(19) United States
(12) Patent Application Publication
(10) Pub. No.: US 2011/0188243 A1
(43) Pub. Date: Aug. 4, 2011

(54) THREE-DIMENSIONAL LIGHT BOARD

(75) Inventor: Bu Go Park, Sosa-gu (KR)

(73) Assignee: GALAXIA ELECTRONICS CO., LTD.

(21) Appl. No.: 12/843,132

(22) Filed: Jul. 26, 2010

(30) Foreign Application Priority Data
Jan. 29, 2010 (KR) 10-2010-0008748

(51) Int. Cl. F21S 8/00

(52) U.S. Cl. 362/235

(57) ABSTRACT

Disclosed herein is a 3D light board. The 3D light board includes a frame, a light emitting module coupled to a front side of the frame and including light emitting diodes emitting light in response to a signal from a controller, and a 3D filter provided to a front side of the light emitting module to polarize light emitted from the light emitting diodes.

### FIELD OF TECHNOLOGY

The present invention relates to a three-dimensional light board and, more particularly, to a three-dimensional light board that realizes a three-dimensional image through a simple structure enabling detachable attachment of a three-dimensional filter.

### BACKGROUND

A light emitting diode (LED) refers to a semiconductor device that emits light, and is used for various electronic components and electronic display panels, such as instrument panels and the like, to emit various colors such as red, green, blue, yellow, etc.

Among such electronic display panels, a three-dimensional light board includes a plurality of LEDs arranged in a matrix to form pixels for displaying an image, thereby enabling the image to be displayed thereon.

In recent years, various attempts have been made to replace a display device of a two-dimensional substrate and realize a three-dimensional image. For example, Korean Patent Publication No. 2003-0093534, entitled “Adapter for 3-dimensional photographing device” and Korean Patent Publication No. 2003-0093533, entitled “Adapter for 3-dimensional photographing device” disclose techniques for capturing a right image and a left image at the same time through a single photographing device.

In such a three-dimensional imaging system, a pair of images corresponding to a right-side eye and a left-side eye, that is, a right image and a left image, are photographed and a three-dimensional image is then projected on a screen 100 through a left projector 210 for projecting the left image and a right projector 220 for projecting the right image, as shown in FIG. 1.

Here, light projected from the left projector 210 passes through a vertical polarization filter 310 and is then projected on the screen 100, and light projected from the right projector 220 passes through a horizontal polarization filter 320 and is then projected on the screen 100. Further, when a user views the screen through polarized glasses 3 having a vertical polarizing filter and a horizontal polarizing filter at left and right sides of the glasses, the image displayed on the screen is viewed as a three-dimensional image.

The aforementioned technique provides background information to help understand the present invention and is not a conventional technique well known in the art to which the present invention pertains.

Since a conventional light board can realize only a two-dimensional image, it does not satisfy a user, and since a conventional three-dimensional imaging system requires two projectors for projecting right and left images, it consumes high costs for installation.

Therefore, there is a need for an improved three-dimensional light board that overcomes such problems.

### SUMMARY

The present invention is conceived to solve the above problems, and an aspect of the invention is to provide a three-dimensional light board that can realize a three-dimensional (3D) image through a simple structure enabling detachable attachment of a 3D filter.

In accordance with an aspect of the present invention, a three-dimensional light board includes: a frame; a light emitting module coupled to a front side of the frame and including light emitting diodes emitting light in response to a signal from a controller; and a 3D filter provided to a front side of the light emitting module to polarize light emitted from the light emitting diodes.

The 3D filter may include a right circular polarization film having first penetration holes separated at constant intervals from one another to change a refractive index of light projected to the right circular polarization film, and a left circular polarization film having second penetration holes alternating with the first penetration holes to allow light projected to the right circular polarization film to pass therethrough and to change a refractive index of light projected to the left circular polarization film.

The 3D light board may further include a guide panel located at a front, rear or either side of the 3D filter and having guide holes in one-to-one correspondence with the light emitting diodes to guide light emitted from the light emitting diodes.

The guide panel and the 3D filter may be formed with fastening holes coincident with each other to allow the guide panel and the 3D filter to be fastened to the frame through the fastening holes by a screw.

### BRIEF DESCRIPTION OF THE DRAWINGS

The above and other aspects, features and advantages of the invention will become apparent from the detailed description in conjunction with the accompanying drawings, in which:

FIG. 1 is a view of a conventional 3D imaging system;

FIG. 2 is a perspective view of a 3D light board in accordance with an embodiment of the present invention;

FIG. 3 is an exploded perspective view of a 3D film of the 3D light board in accordance with the embodiment of the present invention;

FIG. 4 is an assembled perspective view of the 3D film of the 3D light board in accordance with the embodiment of the present invention;

FIG. 5 is a detailed view of the 3D film of the 3D light board in accordance with the embodiment of the present invention; and

FIG. 6 is a view showing operation of the 3D film of the 3D light board in accordance with the embodiment of the present invention.

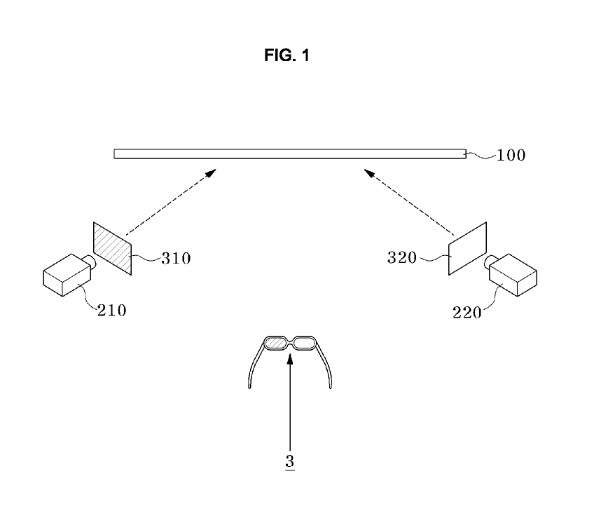

### DETAILED DESCRIPTION

Embodiments of the invention will now be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosure set forth herein.

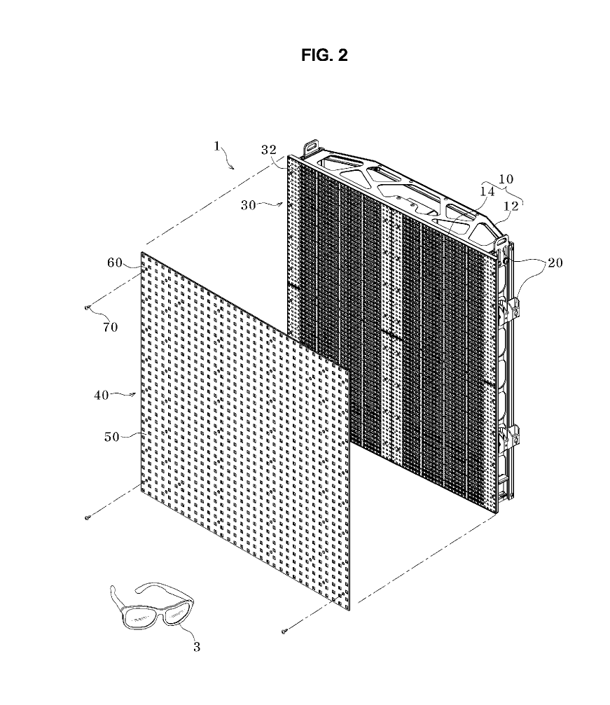

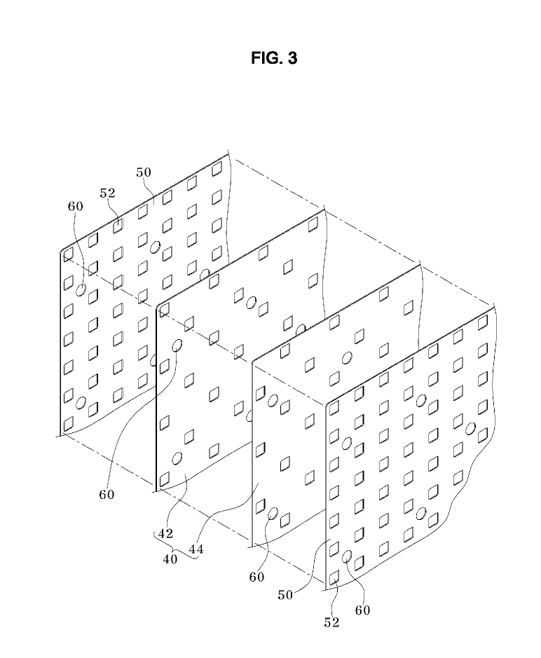

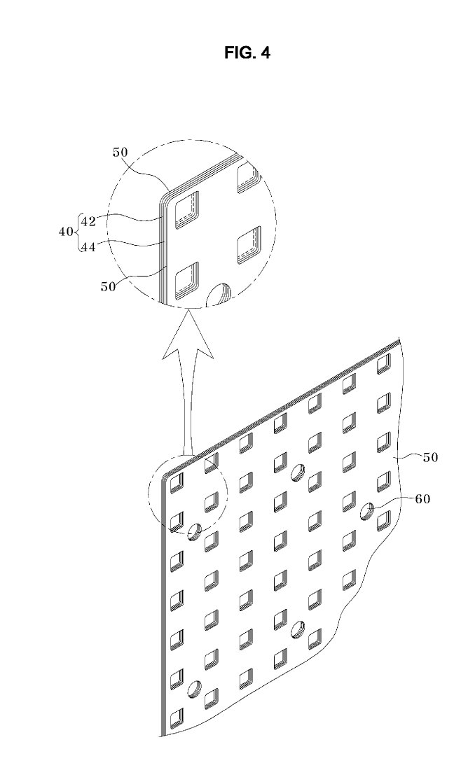

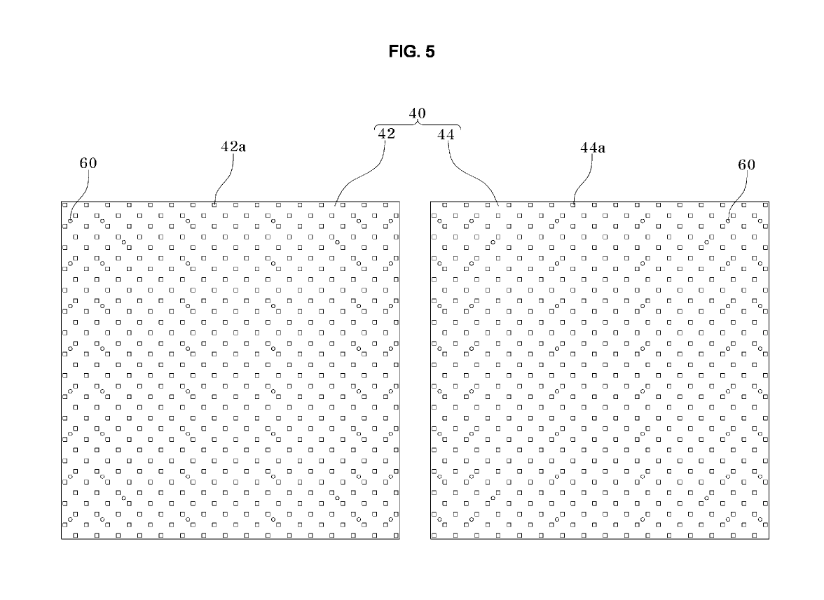

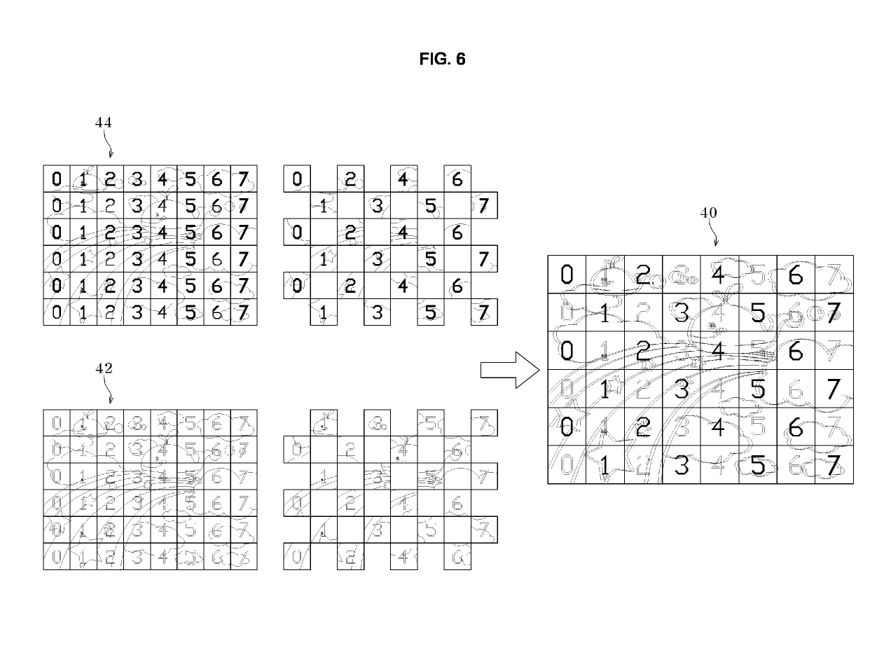

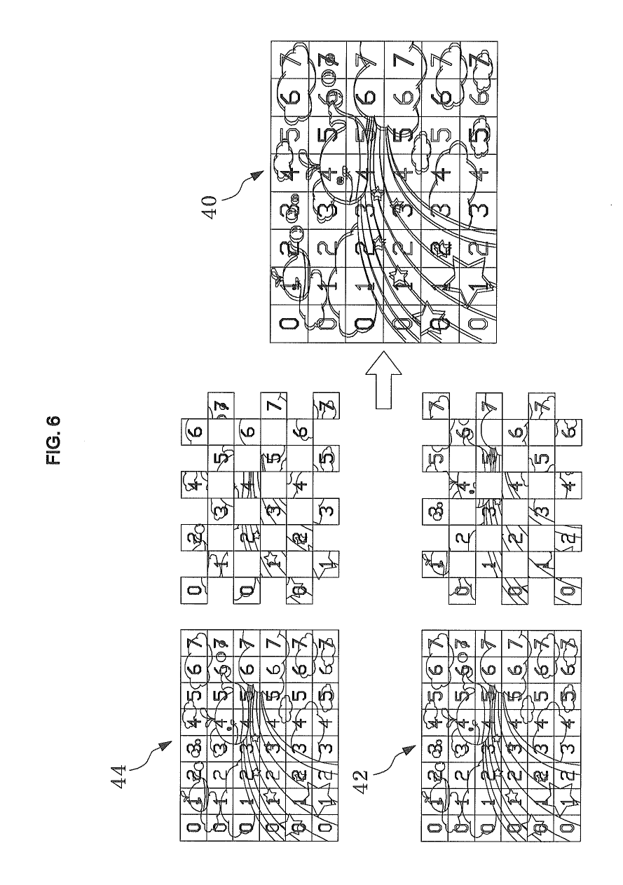

FIG. 2 is a perspective view of a 3D light board in accordance with an embodiment of the invention, FIG. 3 is an exploded perspective view of a 3D film of the 3D light board in accordance with the embodiment, FIG. 4 is an assembled perspective view of the 3D film of the 3D light board in accordance with the embodiment, FIG. 5 is a detailed view of the 3D film of the 3D light board in accordance with the embodiment; and FIG. 6 is a view showing operation of the 3D film of the 3D light board in accordance with the embodiment.

Referring to FIGS. 2 to 6, a 3D light board 1 according to one embodiment of the invention generally includes a frame 10, a light emitting module 30, and a 3D film 40.

The frame 10 includes outer frames 12 and a main frame 14. The outer frames 12 include horizontal frames disposed parallel to each other at upper and lower sides of the 3D light board 1 to face each other, and vertical frames coupled to opposite sides of the horizontal frames, respectively.

The main frame 14 has a rectangular shape and is provided with the light emitting module 30 coupled to a front side of the main frame 14.

The frame 10 is configured to have a light weight and may be formed of aluminum.

The frame 10 may be extended in vertical and horizontal directions by extension members 20 to be formed as a large frame.

The light emitting module 30 includes a plurality of light emitting diodes 32 to form plural pixels for displaying an image.

The light emitting module 30 in front of the frame 10 emits light in response to a signal from a controller (not shown).

The 3D filter 40 is adjacent to a front side of the light emitting module 30.

The 3D filter 40 includes a right circular polarization film 42 having first penetration holes 42a separated at constant intervals from one another to change a refractive index of light projected to the right circular polarization film 42, and a left circular polarization film 44 having second penetration holes 44a alternating with the first penetration holes 42a to allow light projected to the right circular polarization film 42 to pass therethrough and to change a refractive index of light projected to the left circular polarization film 44.

Here, the first penetration holes 42a of the right circular polarization film 42 alternate with the second penetration holes 44a of the left circular polarization film 44 so that the first and second penetrations holes alternately correspond to the light emitting diodes 32.

In other words, when a user views an image with polarized glasses 3, light emitted from the light emitting diodes 32 and projected to the left circular polarization film 44 forms an image which can be seen only by a left-side eye of the user, and light emitted from the light emitting diodes 32 and projected to the right circular polarization film 42 forms an image which can be seen only by a right-side eye of the user.

This is possible because the polarized glasses 3 are provided with left and right circular polarization films at the left and right sides thereof, respectively.

Further, the 3D light board is provided with a guide panel 50, which is located at a front, rear or either side of the 3D filter 40 and has guide holes 52 in one-to-one correspondence with the light emitting diodes 32 to guide light from the light emitting diodes 32.

The guide panel 50 may have a black color, so that the guide panel 50 can accurately guide light emitted from the light emitting diodes 32 in a front direction and enhance luminous intensity of the light.

The guide panel 30 may be formed of a rigid material to protect the 3D filter 40 from external impact.

Further, the guide panel 50 and the 3D filter 40 are formed with fastening holes 60 coincident with each other and are fastened to the frame 10 through the fastening holes 60 by screws.

As such, the guide panel 50 and the 3D filter 40 may be detachably attached to the frame 10. Thus, the light emitting module 30 provides a two-dimensional image when the 3D filter 40 is detached from the frame 10, and the light emitting module 30 provides a 3D image through the guide panel 50 and the 3D filter 40 when the 3D filter 40 is attached to the frame 10.

To couple the guide panel 50 and the 3D panel 40 to the frame, various designs may be conceived in addition to the screw. For example, when the guide panel 50 is made of steel, a magnetic panel is secured to the front side of the light emitting module to hold the guide panel 50 on the frame 10 by magnetic force. Alternatively, the guide panel 50 and the 3D panel 40 may be detachably attached to the frame 10 by a hook.

Next, operation and effect of the 3D light board according to the embodiment will be described.

After forming the frame 10 by assembling the outer frames 12 and the main frame 14, the light emitting module 30 is coupled to the front side of the main frame 14.

The frame 10 is provided with a controller (not shown) electrically connected to the to light emitting module 30.

In this state, the controller receives an image signal and controls the light emitting module 30 to display an image corresponding to the image signal, so that a two-dimensional image is realized.

On the other hand, to realize a 3D image, the 3D filter 40 is coupled to the front side of the light emitting module 30.

The 3D filter 40 is provided at front and rear sides thereof with the guide panels 50, and the 3D filter 40 and the guide panels 50 are secured to the frame 10 through the fastening holes 50 coincident with each other.

Next, operation of the 3D filter to realize a 3D image will be described with reference to FIG. 6. When the light emitting diodes 32 of the light emitting module 30 emit light in response to a signal from the controller, the light is polarized according to characteristics of the respective polarization films 42, 44 while passing through the first penetration holes 42a of the right circular polarization film 42 and the second penetration holes 44a of the left circular polarization film 44, which are formed to alternate with one another.

In other words, when delivered to a user, light projected to the left circular polarization film 44 forms an image that can be seen only by a left-side eye of the user, and light projected to the right circular polarization film 45 forms an image that can be seen only by the right-side eye of the user, so that the user wearing the polarized glasses 3 can view a 3D image.

Further, the 3D filter 40 is protected from external impact by the guide panels 50 disposed at the front and rear sides of the 3D filter 40.

Further, the guide panel 50 is formed with guide holes 52 which are in one-to-one correspondence with the light emitting diodes 32 to allow light projected through the 3D filter 40 to be accurately guided in the front direction through the guide holes. The guide panels 50 have a black color, thereby enhancing luminous intensity of the light.

As such, the 3D light board can realize a 3D image through a simple structure enabling detachable attachment of the 3D filter 40 to the front side of the light emitting module 30.

As apparent from the above description, the 3D light board of the embodiment is provided at the front side thereof with a 3D filter to polarize light emitted from light emitting diodes when the light is projected to a screen, thereby realizing a 3D image.

Further, according to the embodiment, the 3D light board is provided with a guide panel at the front, rear or either side of the 3D filter, thereby enhancing luminous intensity of light emitted from the light emitting diodes while protecting the 3D filter

Although some embodiments have been provided to illustrate the invention in conjunction with the drawings, it will be apparent to those skilled in the art that the embodiments to are given by way of illustration only, and that various modifications, changes, alterations, and equivalent embodiments can be made without departing from the spirit and scope of the invention. The scope of the invention should be limited only by the accompanying claims.

What is claimed is:

1. A three-dimensional (3D) light board comprising:
a frame;
a light emitting module coupled to a front side of the frame and including light emitting diodes emitting light in response to a signal from a controller; and
a 3D filter provided to a front side of the light emitting module to polarize light emitted from the light emitting diodes.

2. The 3D light board of claim 1, wherein the 3D filter comprises a right circular polarization film having first penetration holes separated at constant intervals from one another to change a refractive index of light projected to the right circular polarization film, and a left circular polarization film having second penetration holes alternating with the first penetration holes to allow light projected to the right circular polarization film to pass therethrough and to change a refractive index of light projected to the left circular polarization film.

3. The 3D light board of claim 1, further comprising:
a guide panel located at a front, rear or either side of the 3D filter and having guide holes in one-to-one correspondence with the light emitting diodes to guide light emitted from the light emitting diodes.

4. The 3D light board of claim 3, wherein the guide panel and the 3D filter are formed with fastening holes coincident with each other to allow the guide panel and the 3D filter to be fastened to the frame through the fastening holes by a screw.
